(19) United States
(12) Patent Application Publication
(10) Pub. No.: US 2005/0240512 A1
(43) Pub. Date: Oct. 27, 2005

(54) Method and system for identifying auction items in a graphical location

(75) Inventors: Andrew H. Quintero, Marina Del Ray, CA (US); Alan G. Quan, Pasadena, CA (US)

Correspondence Address: MORGAN, LEWIS & BOCKIUS LLP, 2 Palo Alto Square, 3000 El Camino Real, Palo Alto, CA, 94306, US

(73) Assignee: NACenters, Inc., El Segundo, CA (US)

(21) Appl. No.: 11/061,675

(22) Filed: Feb. 18, 2005

Related U.S. Application Data
(60) Provisional application No. 60/545,613, filed on Feb. 18, 2004.

(51) Int. Cl. G06F 17/60

(52) U.S. Cl. 705/37

(57) ABSTRACT

Location based results are generated for on-line marketing, merchandise searches, and auction items searches. A candidate buyer sets search criteria in an on-line search engine which may include location conditions. Results are presented either graphically or in list form showing the proximity of not only stores that have items that meet the criteria, but the general distance from a reference location. The reference location may be the person's address, a local landmark, a zip code, or other location. According to some condition, only established businesses with actual store fronts or physical locations (which allow for the user to physically inspect the auction item and/or make a risk assessment of doing business with the vendor) are permitted to offer items for auction or be on the selling end of the transaction.

### TECHNICAL FIELD

The present invention relates generally to the on-line purchase of goods, and in particular to on-line auctions.

### BACKGROUND

During the internet boom in the late 1990s, large enterprises dominated the market and the resources required to participate in the internet economy were essentially beyond the reach of the small to medium enterprises. Many small independent stores were faced with tough challenges since in many cases they did not understand the internet concept, and worse, in many cases did not even own a computer. Many still do not, or the proprietors do not have the experience or resources to establish a web presence. This translates into an inability to participate using the internet-based marketing vehicle and prevents them from exploiting the benefits of additional revenue from being on-line. Additionally, a significant amount of development being done for the web focuses on the web's capability for global reach and not on more local efforts.

In many instances, however, a more local approach is desired. Therefore, what is needed is a system and method that permits business to capitalize on both a web presence and a local brick and mortar presence concurrently.

### SUMMARY

According to some embodiments, a method of providing an on-line auction includes maintaining a database of vendor physical store locations where items offered for auction may be examined, each vendor physical store location associated with a respective vendor. An auction search request is received from a search requester, where the auction request includes item description information and a location condition. Auctions relevant to the item description information and satisfying the location condition are identified where each auction is associated with a respective auction vendor. Distance information is determined for each of the identified auctions in accordance with a distance parameter and a least a portion of the identified auctions are returned to the search requester.

### BRIEF DESCRIPTION OF THE DRAWINGS

The aforementioned features and advantages of the invention as well as additional features and advantages thereof will be more clearly understood hereinafter as a result of a detailed description of embodiments of the invention when taken in conjunction with the drawings. Like reference numerals refer to corresponding parts throughout the several views of the drawings.

FIG. 1 depicts a block of a system in accordance with some embodiments of the present invention.

FIG. 2 depicts a process for returning auctions in accordance with some embodiments of the present invention.

FIG. 3 depicts a screenshot of an exemplary list of auctions in accordance with some embodiments of the present invention.

FIG. 4 depicts a screenshot of an exemplary map of auction locations in accordance with some embodiments of the present invention.

FIG. 5 depicts a process for responding to requests for mapping results in accordance with some embodiments of the present invention.

FIG. 6 depicts a process for accepting bids in accordance with some embodiments of the present invention.

FIG. 7 depicts a process for responding to a bid notification in accordance with some embodiments of the present invention.

FIG. 8 depicts a process for a CRM tool in accordance with some embodiments of the present invention.

FIG. 9 depicts a personal client device in accordance with some embodiments of the present invention.

FIG. 10 depicts a client in accordance with some embodiments of the present invention.

FIG. 11 depicts a management system in accordance with some embodiments of the present invention.

### DESCRIPTION OF EMBODIMENTS

According to some embodiments of the invention, geolocation based results are generated for on-line marketing, merchandise searches, and auction items searches. A candidate buyer sets search criteria in an on-line search engine which may include location conditions via zip code, miles distance, or otherwise. The results are presented either graphically or in text generated list format showing the proximity of not only stores that have items that meet the criteria, but the general distance from a reference location. The reference location may be the person's address, a local landmark, a zip code, or other location. Often times, a person would like to purchase or bid on an auction item, but prefers to have the option of touching, feeling, or otherwise inspecting the item. According to some embodiments, only established businesses with actual store fronts or physical locations (which allow for the user to physically inspect the auction item and/or make a risk assessment of doing business with the vendor) are permitted to offer items for auction or be on the selling end of the transaction. This reduces, or nearly eliminates, potential misrepresentations or actual fraud occurrences since the buyer and auction managers can identify and follow-up on reported fraud cases.

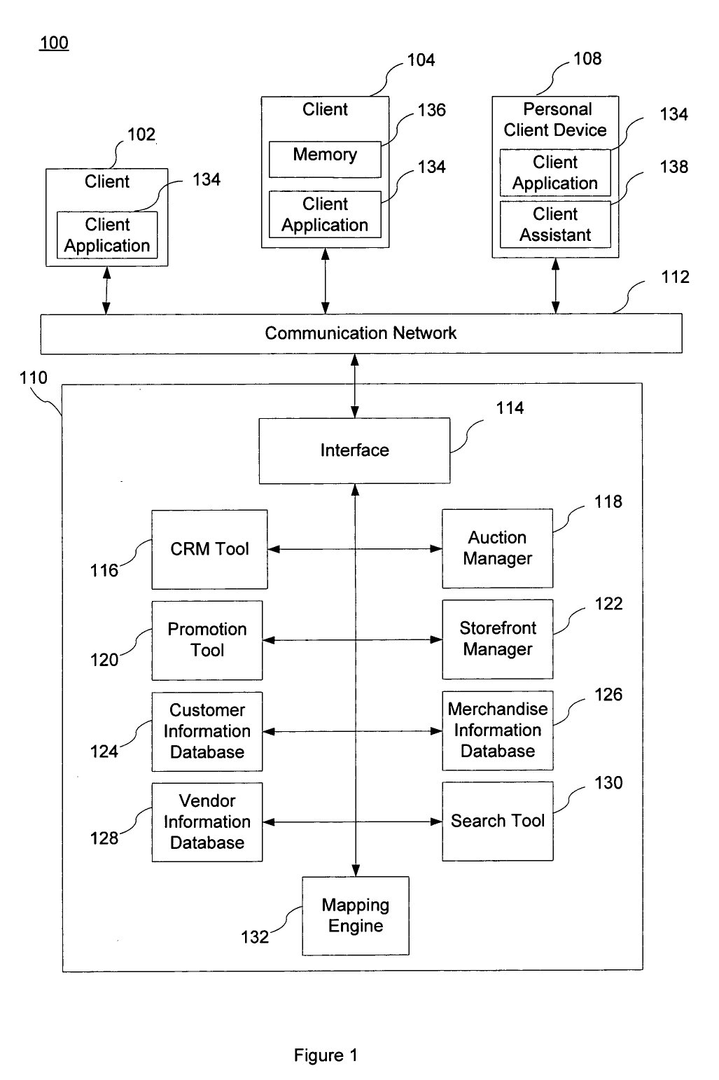

FIG. 1 illustrates an environment 100 in which some embodiments of the invention operate. The system 100 includes a client 102, a client 104 and a personal client device 108 connected to a management system 110 via a communication network 112.

The clients 102, 104, 108 can be any number of devices (e.g., computer, internet kiosk, personal digital assistant, cell phone, gaming device, desktop computer, laptop computer, set-top box) which may be used to connect to the communication network 112. The communication network 112 may be a wireless, optical, wired or other type of network that facilitates the passage of information between the clients 102, 104, 108 and the management system 110. It may include the Internet, one or more local area networks (LANs), one or more wide are networks (WANs), other types networks, or a combination of such networks. The clients 102, 104, 108 include a client application 134. The client application 134 is an application that is executed on the client (e.g., browser, e-mail client, message client) and that displays or presents information to a user of the client (the client application may also perform other tasks not relevant to the present discussion). The client 104 also contains a memory 136 used to store information, such as information pertaining to a vendors operations (e.g., merchandise, customer purchase history). The personal client device 108 includes a client assistant 138. The client assistant 138 is an application that facilitates the processing, display or presentation of information by the client application 134 (e.g., responding to a bid notification). The client assistant 138 can be part of the client application 134, a plug-in to the client application 134, stand-alone application, or otherwise (e.g., a JavaScript application downloaded as part of a message). In some embodiments, the client assistant 138, or portions of the client assistant 138 are downloaded along with messages or other information sent to the client 108. For instance, the client assistant 138 may be one or more scripts (e.g., JavaScript programs) embedded in other content.

In some embodiments, the client 102 is used by consumers to search for items to purchase or examine (though it may be used for other activities as well). In some embodiments, the client 104 is used by vendors having one or more items to offer for sale (though it may be used for other activities as well). In some embodiments, the personal client device 108 is used by a consumer to receive messages associated with a user's bid (though it may be used for other activities as well). In some embodiments, the personal client device 108 is a cell phone, personal digital assistant, or other wireless device. In some embodiments, it is sufficient that the personal client device 108 being a client device a user is likely to be mobile with. It should be noted that the clients 102, 104, 108 may contain additional components or features not described herein and nothing should be construed to limit the devices to the particular configuration in FIG. 1.

The management system 110 provides a number of features to vendor and customers in some embodiments, the features are accessed via a web site accessible via client application 134. In some embodiments, the management system 110 includes an interface 114, a CRM tool 116, an auction manager 118, a promotion tool 120, a storefront manager 122, a customer information database 124, a merchandise information database 126, a vendor information database 128, a search tool 130 and a mapping engine 132, operably interconnected.

The interface 114 provides a interface between the communication network 112 and the other components in management system 110. The interface 114 directs incoming communications to the appropriate component and transmits communications intended for the clients from the various components.

The CRM tool 116 manages aspects of a customer relationship management feature (e.g., allowing vendors to manage and track their customers). According to some embodiments, it includes managing a customer address database; a merchandise database; a purchase history database; a customer event database; a promotion generation tool and database; and a reports and document printing resource for printers and/or for on-line distribution.

The auction manager 118 manages aspects an on-line auctions provided by the management system 110. Vendors use part of the auction manager 118 to create, monitor and manage auctions. Consumers interact with the auction manager 118 to participate in auctions and to set up provisions for bid notifications. The auction manager 118 communicates bid information to consumers participating in the auction in accordance the consumer's preference settings. The auction manager 118 also manages the individual auctions themselves, accepting bids and determining the current high bidders, as well as possibly performing other functions as well. Bidders are permitted to bid on various auction items using a variety of bid types.

The promotion tool 120 is used in conjunction with the CRM tool 116 to create custom tailored mailers (e-mail or regular mail), produce coupons, flyers (with or without photos) and targeted promotions.

The storefront manager 122 enables vendors to create a semi-customizable web site, or “storefront,” providing access to the vendor's auction listings and on-line merchandise catalog, along with web site information (e.g. “about us”, “locations”, ”contact us”, etc.). The “storefront” web page and online merchandise catalog may provide a forum for the client/seller to offer products online, with typical features of an e-commerce web site, such as information about the business, products offered, and methods of contact.

The customer information database 124, contains information about customers of the vendors. Vendors enter, edit or otherwise modify information such as purchase history, customer events (e.g., birthdays, anniversaries) and customer preferences. Various reports may be run analyzing a vendor's customer information. It should be noted that appropriate security provisions are implemented in the management system 110 to prevent vendors from accessing information of other vendors without appropriate permissions (nor are customers allowed to access vendor information without permission).

The merchandise information database 126 stores information about items available for purchase or auction by vendors. The information in merchandise information database 126 is entered by the vendors to manage their on-line catalog and identify items for auction. The items may be searched and browsed by visitors to a web site associated the management system 110. Vendors can select items from the merchandise information database 126 for auction.

The vendor information database 128 contains information about the vendors, such as the physical store location, contact information, store description, and so on. In some embodiments, a vendor is prohibited from initiating an auction or making its catalog available for access by users who access the management system 110 until the vendor's physical address has been validated. In some embodiments, a vendor's entered store location information is validated by comparing the entered information with third party sources (e.g., yellow pages, Secretaries of State records, Better Business Bureau records). In some embodiments, system administrators manually validate a vendor's store location by any of a number of means (e.g., physical examination). Validation of the vendor's physical store location information assists in reducing the potential of fraud or misrepresentation by vendors. Additionally, a validated address increases the added benefit to a user of the management system 110 such that a user deciding whether to bid on an auction item or purchase an item from an on-line catalog may visit the vendor's location to evaluate the auction item and/or the vendor itself.

The search tool 130 allows users (e.g., customers, vendors) of the management system 110 to search various databases for relevant items. For example, user may search for relevant auctions, vendors and catalog items. As another example, a vendor may search for customer information or purchase history for its customers.

The mapping engine 132 permits mapping information to be created. In some embodiments, a map is created showing a number of identified locations highlighted on a map of a geographical area. In some embodiments, a map is created laying out a path of travel from one location to another (e.g., from a user's location to a vendor's physical store location).

It should be noted that FIG. 1 is merely exemplary and intended to provide a general overview of the functions performed by the environment 100 and not a strict partitioning of the elements. In some embodiments, the management system 110 includes a subset or superset of the function listed. In some embodiments, some of the components may be implemented on more than one server (e.g., the customer information database 124 may be implement on a plurality of servers designed to function as one virtual database). In some embodiments, components illustrated as separate may be combined (e.g., the mapping engine 132 and search tool 130 may be implemented on a single server).

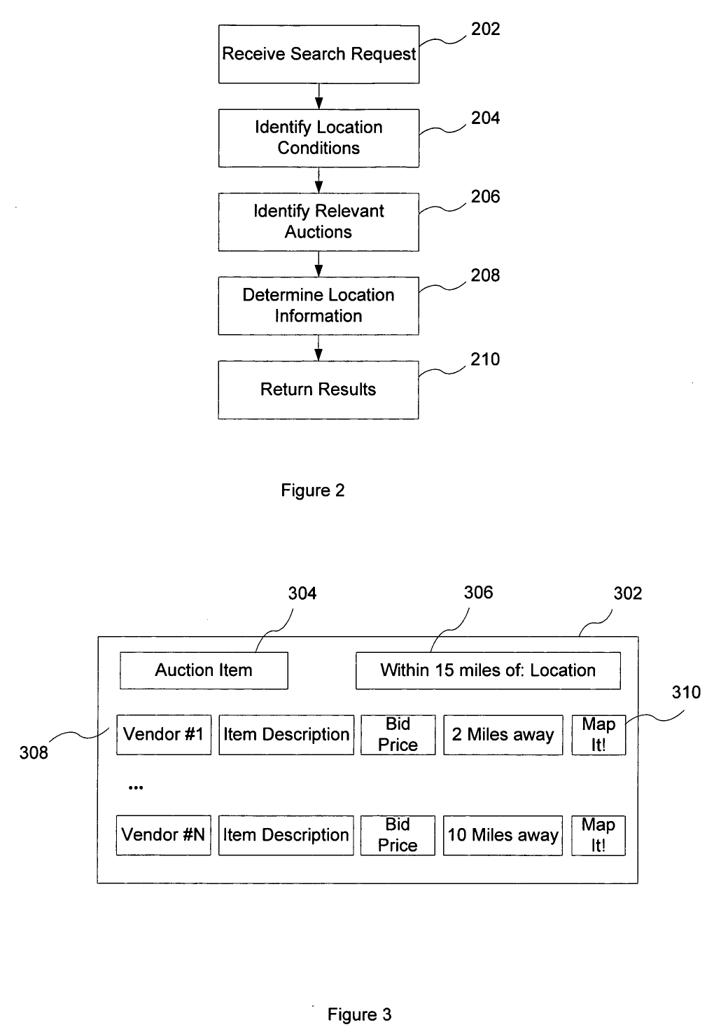

In some embodiments, one of the features provided by the management system 110 is the ability for a user to search for auction having according to certain location conditions. FIG. 2 illustrates a process for searching for relevant auctions according to some embodiments of the invention. A user of the management system 110 can enter the search request for any auction via a client application 134 (e.g., a web browser) using a web site interface provided by the interface 114. In some embodiments, the user enters location information to narrow the search to auctions within a defined geographical region (e.g., satisfying a location condition). A user may be interested in identifying items for auction which are located at places the user may desire to visit before entering a bid in the auction. A user may be more interested in an item that is closer to the user than those which are further away. In some embodiments, the user enters location information indicating that the user desires to see auctions where the vendor associated with the auction item is located within an entered distance from a location entered by the user (e.g., the user selects an option “find auctions within” and enters a distance parameter). In some embodiments, the user enters the user's home address as the location from which the distance is to be measured. In some embodiments, the user enters a known location as the location from which the distance is to be measured. In some embodiments, the user enters a zip code. One of ordinary skill in the art will readily recognize other ways to enter location defining information (e.g., city, street intersections, and so on) without departing from the scope of the invention.

The search request is received by the search tool 130 (202). From the request, the location conditions are identified (204) (e.g., within 5 miles from the entered location). From the available auctions, relevant auctions are identified (206). In some embodiments, auctions are identified in information associated with a particular item in the merchandise information database 126. In some embodiments, only auctions which meet the location condition are identified. In some embodiments, auctions meeting the proximity limits are identified as well as auctions near the location condition (i.e., just beyond the user's condition). In some embodiments, the search tool 130 enhances or modifies the user's entered search query to increase the likelihood that that the search will return auctions that the user is interested in. In some embodiments, the search tool 130 applies well known stemming operations to the search terms entered by the user (e.g., plural/singular). In some embodiments, the search tool 130 determines and searches for a class of objects to which the entered search terms belongs (e.g., a user may enter “plates” and the search tool 130 may include auctions belonging to a category of “china”). In some embodiments, the search tool 130 identifies obviously misspelled words and replaces and/or adds the corrected spelling to the search query.

From the identified auctions (at 206), location information for vendors associated with the auctions is determined (210). For example, the distance to each of the vendors from the location supplied by the user is determined. The set of results is ordered in accordance with the distance from the entered location. In some embodiments, the auctions are ordered in increasing distance from the entered location (i.e., the auction having a corresponding vendor location closest to the entered location is at the top of the result list). The results are then returned to the client 102, 104, 108. In some embodiments, only a portion of the identified auctions are returned to the client 102, 104, 108 due to display restrictions. In some embodiments, the search request includes information indicating a maximum number of results to return. In some embodiments, a predefined number of the total number of results are returned and subsequent requests return the next predefined number of results from the set of search results (e.g., a user may page through the set of results).

Although the above searching discussion mentioned auctions, the techniques apply equally well to users searching for vendors and/or catalog items (which may or may not be up for auction). In some embodiments, a user is provided with selectable options on the search screen which are used to define the search categories (e.g., one or more of vendors, auctions, catalog items).

FIG. 3 illustrates a exemplary return of search results for an auction search according to some embodiments of the invention. A results window 302 includes an auction item portion 304 corresponding to the user's entered search request (e.g., “trumpet”) and a location condition portion 306 corresponding to the location condition entered by the user (e.g., with 15 miles of zip code 94107). A number of auction results such as result 308 are returned. Among the information which could be displayed include the name of the vendor, the vendor's description of the item, the latest bid price, the distance from the user's entered location, and a map button 310. It should be noted that the results windows 302 is merely exemplary and a subset or superset of the information there may be presented to the user.

If the user selects the map button 310 it generates a request to the management system 100 for map directions from the user's entered location. In some embodiments, selecting the map button 310 produces a map of the geographical location surrounding the vendor's location.

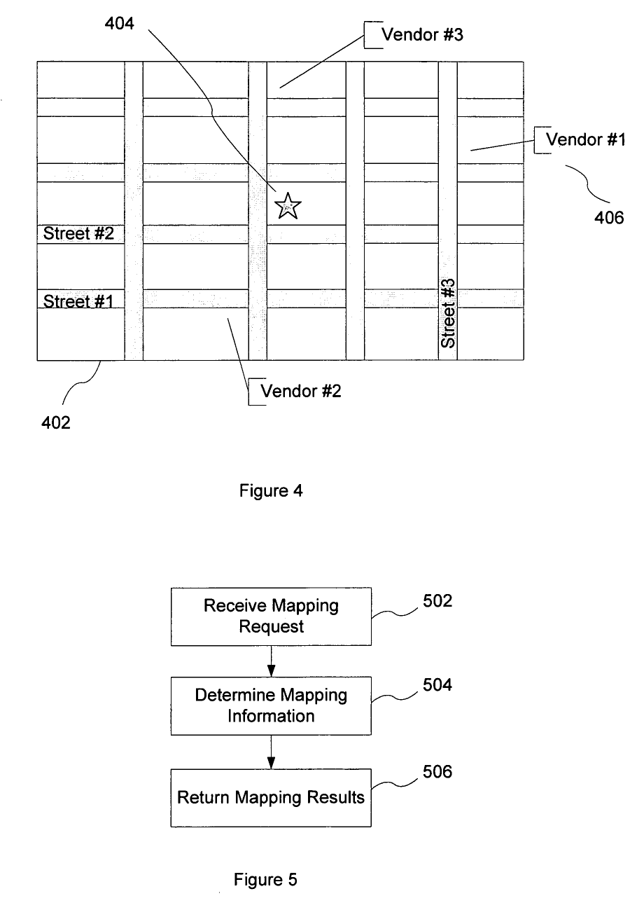

In some embodiments, the results of an auction search are returned in map form. For example, the results are returned highlighting respective vendor locations on a map relative to the user's entered location. In such embodiments, the mapping engine 132 determines a map location for each of the vendors of the relevant auctions and overlays that information on a map of a region in accordance with the user's entered location condition. In some embodiments, both results information and map information are returned. FIG. 4 illustrates an exemplary map result return 402. In some embodiments, a location 404 represents the location entered by the user. A number of vendor locations (e.g., vendor location #1 406) are indicated on the map 402 displaying to the user the location of the vendors in relation to the user's entered location. In some embodiments, a user may select the vendor's name for more information about the vendor or the auction.

FIG. 5 illustrates a process of responding to a map request. Initially a map request is received (502). From the map request, mapping information is determined (504). The form and type of mapping information depends on the type mapping request received. In some embodiments, the map request is for directions from the user's entered location to the location of a vendor (e.g., from results window 302). In some embodiments, the map request is for driving directions from the user's entered location to the location of a vendor (e.g., from map window 402). Once the map information is generated, it is returned to the requesting client (and therefore to the requesting user). In some embodiments the map information is returned as a set of driving directions from the user's entered location to the vendor; in some embodiments the map information highlights a travel path on a map from the user's entered location to the vendor; and in some embodiments, it is a combination of the two.

The management system 110 in some embodiments offers an auction capability via a online web interface. Any currently running auctions for vendors can be displayed. Auctions can be searched for by category and/or keyword. Information on merchandise to be auctioned is posted merchandise information database 126 by vendors (e.g., store owners/agents). Auction information includes minimum bid, reserve price, auction start and end times, merchandise id, and merchandise description. When the auction start time has been reached, the auction is automatically initiated and the auction page for that auction becomes viewable on the applicable web site. In some embodiments, an auction page contains: starting bid, current high bid, user name of high bidder, whether or not reserve has been met, merchandise description, auction start time, auction end time, and time remaining until close of auction. Bidders can register at any time to be eligible to bid on an auction. A prospective buyer enters their bidder information which includes, for example, bidder user name, password, and email address. Once a bidder is registered he can then bid on any currently active auction. To do this the bidder navigates to the auction page for the item of interest. According to some embodiments, the bidder can make two kinds of bids:
1. A one-time bid that allows the bidder to make a single bid on an item. A one-time bid can be made as many times as the bidder desires for a given auction. The bid must be higher than the current high bid in order to be accepted.
2. An incremental bid that allows the user to specify a starting bid, an increment to be added to his bids, and a maximum bid. The starting bid must be higher than the current high-bid in order to be accepted. Whenever another bidder outbids the bidder's incremental bid, the increment value is added to the incremental bidder's last bid value until it either exceeds the current high bid or reaches the bidder's maximum bid. When the incremental bid reaches the maximum bid no further amount is added to the bid, regardless of whether it exceeds the current high bid.

When two bidders bid the same amount for an auction item, the first bid received is the one accepted and all future bids must exceed that bid. Thus two or more bidders cannot make the same bid amount for a given auction.

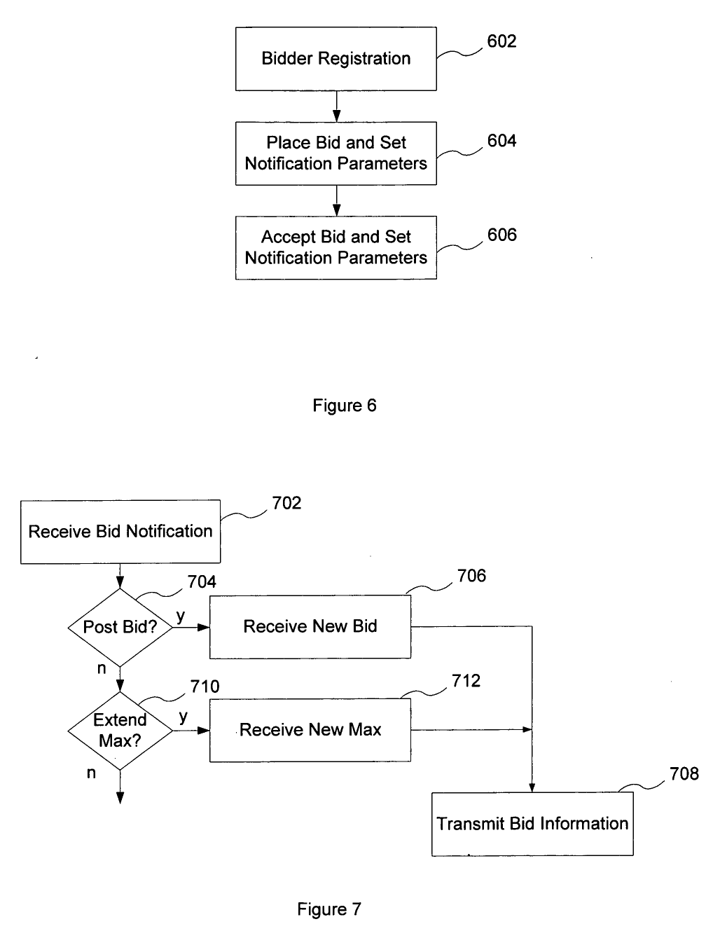

FIG. 6 illustrates a bidding process by a user according to some embodiments of the invention. Before a user may bid on any auction item, the user must register with the management system 110 (602). That may include, for example, entering the user's name, United States postal address, email address, credit card information and so on. Once the user has registered, the user is permitted to bid on an item offered for auction and set notification parameters (604). [bid setting] According to some embodiments, a user is permitted to set certain notification parameters such as being notified via email of certain conditions. If the bid is accepted, the notification parameters are set by the auction manager 118 (606).

The auction manager 118 according to some embodiments, provides the capability to notify the user of bidding activity by other bidders in auctions in which the user has made a bid. Some of the notification options include:
1. Notification of any new high bid that exceeds a user's maximum bid or one-time bid.
2. Notification of a new high bid that exceeds a percentage of user's maximum bid (for incremental bids only).
3. Notification of a new high bid by a registered “competitor” of the user.
4. Notification of a new high bid within one hour of the close of an auction.

One of the ways a user can choose to have bid notification delivered to the user is via a messaging system (e.g., voice message, instant message, wireless message, e-mail message and the like, or any combination thereof). In some embodiments, one or more of these message type are received at the personal client device 108.

Some embodiments of the invention permit the user to respond immediately to the bid notification. The client assistant 138 on the personal client device receives the notification message and pops up a special display for review and action by the user. In response to the notification, the user may be given the option to post a new one-time bid or extend their maximum bid for incremental bidding. To exercise one of the options the user may select one of two buttons in the display and then enters the new bid information. The user then submits the information which is transmitted back to the auction manager 118 and the new bid is entered into an auction database. Messaging notifications occur according to the notification option(s) that the user has previously selected. Users without personal client devices 108 can be notified of bid activity via one of the other notification methods, and then respond by clicking a link (displayed in email notification) or navigating to a URL (given by all other notification methods) to an interactive auction activity page which displays the same options as the personal client device interface. This instant interactive capability enhances the auction experience to be more immediate and exciting for a bidder, creating a virtual auction hall where bidders can view and respond to actions by other bidders in near real-time.

FIG. 7 illustrates a processes for handling bid notifications in a client device (e.g., a wireless client device). A bid notification is received (702) by, for example, a client assistant 138 residing on a personal client device 108. The client assistant causes response options to be presented to the user without prior communication to the auction host except for the bid notification (e.g., the management system 110). In prior art systems, a user is required to visit the web page of the auction to enter or modify bid information. The bid response options may be presented in a number of ways (e.g., visually, aurally, both or other). It is sufficient that the user be presented and provided with a way to select one or none of the options. For example, a button could be displayed on the client display for each option and the user may select one of the buttons. In some embodiments, one of the options permits the user to post a new one-time bid and the other permits the user to increase the maximum bid if the user had selected incremental bidding. Accordingly, if the user selects the one-time bid post (704—yes) then the user enters a new bid (706) and the information is transmitted to the auction manager 118 (708). On the other hand, of the user does not select the one-time bid option (704-n) then in some embodiments, the user may opt for the raising of the maximum bid. If the user decides to raise the maximum bid (710-y) then the user enters a new maximum bid (712) and the information is transmitted to the auction manager 118 (708). It is worth nothing that the order of the process is merely exemplary and should not be considered to limit the scope of the invention. For example, the option to raise the maximum bid option could be considered before the one-time bid option, or both could be considered in parallel.

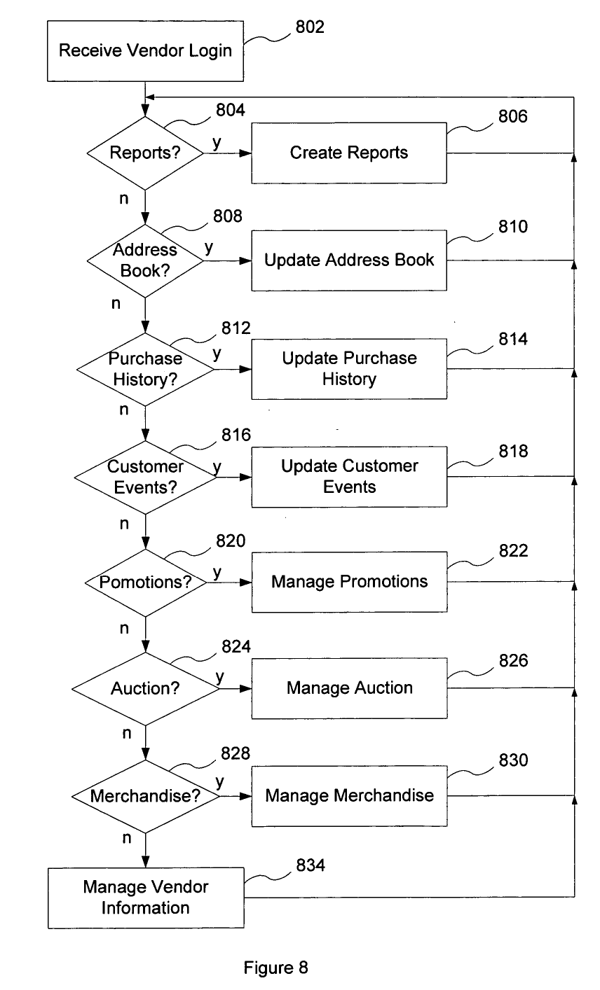

FIG. 8 illustrates a process for a vendor to interact with the CRM tool 116 according to some embodiments of the invention. Initially a vendor logs in to the CRM tool 116 (e.g., by entering a user name and password). It is worth nothing that the order of the processes is merely exemplary and should not be considered to limit the scope of the invention. If the vendor choose a reports feature (804-y) then the user may create various types of reports (806) using the information in the various databases to which the vendor is permitted to access. For example, the vendor may create reports on the vendor's auctions, the vendor's customers, the vendor's merchandise and so on, using the information in, for example, the customer information database 124, the merchandise information database 126 and the vendor information database 128. In some embodiments, the vendor may be provided other, or additional, choices.

If the vendor does not choose the reports feature (804—no) but chooses the address book feature (808-y), then the vendors is presented features for managing an address book (810). If the vendor does not choose the address book feature (808—no) but chooses the update purchase history feature (812-y), then the vendors is presented features for entering, editing or otherwise affecting a customer's purchase history (814). In some embodiments, the vendors enters the purchase history manually; in some embodiments the vendor uploads customer purchase history (for one or more purchasers). If the vendor does not choose the purchase history (812—no) but chooses the update customer events feature (816-y), then the vendors is presented features for updating customer events (818) (e.g., anniversaries, birthdays, other important dates). If the vendor does not choose the customer events feature (816—no) but chooses the manage promotions feature (820-y), then the vendors is presented features for managing promotions (820). If the vendor does not choose the promotions feature (820—no) but chooses the manage auction feature (824-y), then the vendors is presented features for managing its auctions (826) (e.g., selecting items form the catalog for auction, setting auction parameters). If the vendor does not choose the auction feature (824—no) but chooses the manage merchandise feature (828-y), then the vendors is presented features for managing its merchandise (830) (e.g., adding to, deleting or otherwise modifying the vendor's merchandise information in the merchandise information database 126). If the vendor does not choose the merchandise feature (828—no), then the vendors is presented features for managing the vendor's information (834) (e.g., physical store address, contact information or other information).

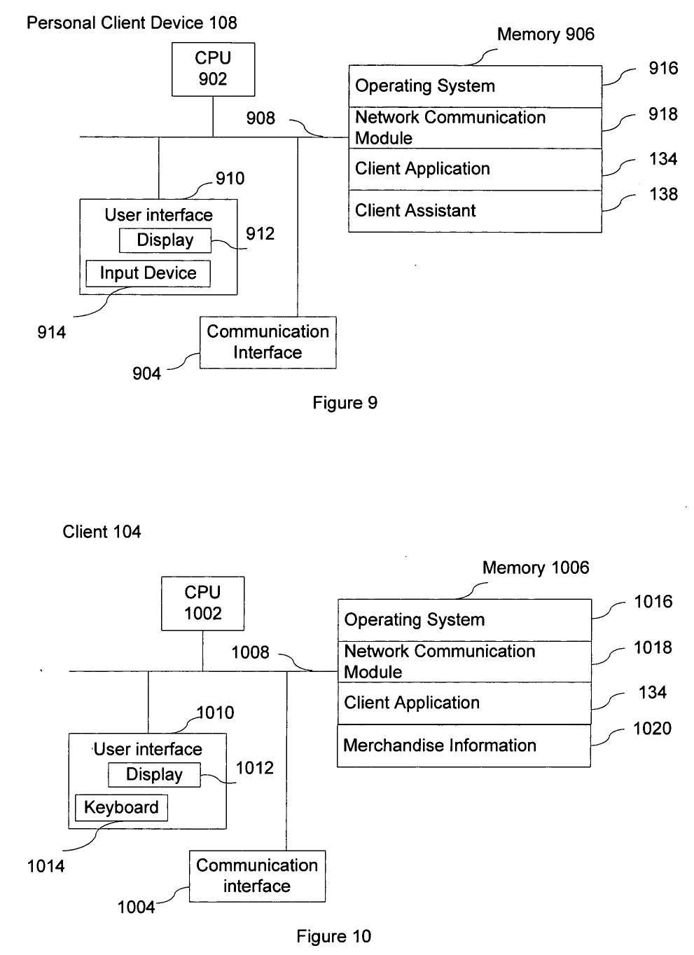

Referring to FIG. 9, a personal client device 108 typically includes one or more processing units (CPU's) 902, one or more network or other communications interfaces 904, memory 906, and one or more communication buses 908 for interconnecting these components. The personal client device 108 may include a user interface 910, for instance a display 912 and an input device 914. The memory 906 may include high speed random access memory and may also include non-volatile memory, such as one or more magnetic or optical storage disks. The memory 906 may include mass storage that is remotely located from CPU's 902. The memory 906 may store the following elements, or a subset or superset of such elements:
an operating system 916 that includes procedures for handling various basic system services and for performing hardware dependent tasks;
a network communication module (or instructions) 918 that is used for connecting the personal client device 108 to other computers via the one or more communications interfaces 904 (wired or wireless), such as the Internet, other wide area networks, local area networks, metropolitan area networks, and so on;
a client application 134 as described above; and
a client assistant 138 as described above.

Referring to FIG. 10, a client system 104 typically includes one or more processing units (CPU's) 1002, one or more network or other communications interfaces 1004, memory 1006, and one or more communication buses 1008 for interconnecting these components. The client system 104 may include a user interface 1010, for instance a display 1012 and a keyboard 1014. The memory 1006 may include high speed random access memory and may also include non-volatile memory, such as one or more magnetic or optical storage disks. The memory 1006 may include mass storage that is remotely located from CPU's 1002. The memory 1006 may store the following elements, or a subset or superset of such elements:
an operating system 1016 that includes procedures for handling various basic system services and for performing hardware dependent tasks;
a network communication module (or instructions) 1018 that is used for connecting the client system 104 to other computers via the one or more communications interfaces 1004 (wired or wireless), such as the Internet, other wide area networks, local area networks, metropolitan area networks, and so on;
a client application 134 as described above; and
merchandise information 1020 containing information pertaining to the vendor's merchandise (e.g., such as a description and whether the merchandise item is participating in an auction).

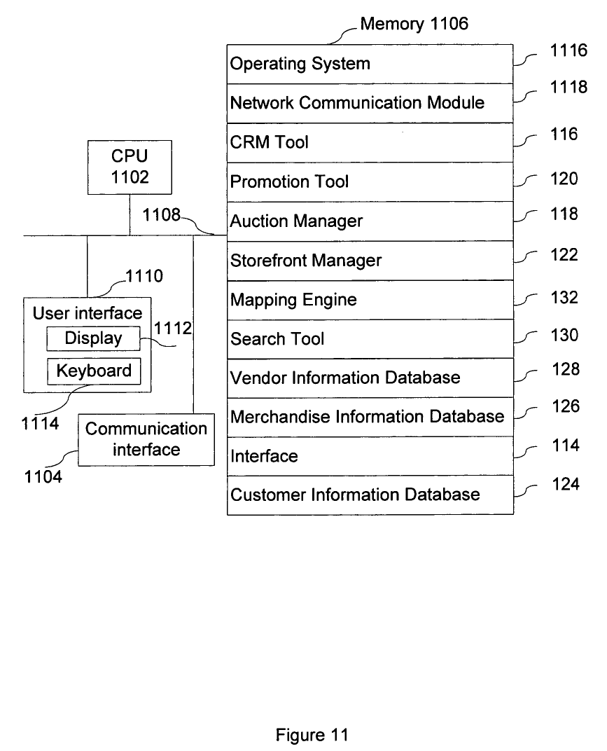

Referring to FIG. 11, a management system 110 typically includes one or more processing units (CPU's) 1102, one or more network or other communications interfaces 1104, memory 1106, and one or more communication buses 1108 for interconnecting these components. The management system 110 may include a user interface 1110, for instance a display 1112 and a keyboard 1114. The memory 1106 may include high speed random access memory and may also include non-volatile memory, such as one or more magnetic or optical storage disks. The memory 1106 may include mass storage that is remotely located from CPU's 1102. The memory 1106 may store the following elements, or a subset or superset of such elements:
an operating system 1116 that includes procedures for handling various basic system services and for performing hardware dependent tasks; and
a network communication module (or instructions) 1118 that is used for connecting the management system 110 to other computers via the one or more communications interfaces 1104 (wired or wireless), such as the Internet, other wide area networks, local area networks, metropolitan area networks, and so on.

The memory 1106 may also store a CRM tool 116 as described above; a promotion tool 120 as described above; an auction manager as described above; a storefront manager as described above; a mapping engine 136 as described above; a search tool 130 as described above; a vendor information database 128 as described above; a merchandise information database 126 as described above; an interface 114 as described above and a customer information database 124 as described above.

In some embodiments of the invention, elements and functional components to this system are developed using standard computer networked database and graphical user interface tools. Examples include web browsers such as Netscape or Explorer; Oracle, mySQL, Sybase or Postgres databases engines; Microsoft Windows, Unix or Linux operating systems; PHP, Java, C++ and other coding languages, etcs.

The foregoing descriptions of specific embodiments of the present invention are presented for purposes of illustration and description. For example, any methods described herein are merely examples intended to illustrate one way of performing the invention. They are not intended to be exhaustive or to limit the invention to the precise forms disclosed. Obviously many modifications and variations are possible in view of the above teachings. The embodiments were chosen and described in order to explain the principles of the invention and its practical applications, to thereby enable others skilled in the art to utilize the and various embodiments with various modifications as are suited to the particular use contemplated. Furthermore, the order of steps in the method are not necessarily intended to occur in the sequence laid out.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method of providing an on-line auction, comprising:
maintaining a database of vendor physical store locations where items offered for auction may be examined, each vendor physical store location associated with a respective vendor;
receiving an auction search request from a search requester, the auction request including item description information and a location condition;
identifying auctions relevant to the item description information;
identifying a respective vendor associated with each auction of the identified relevant auctions;
satisfying the location condition for a respective identified relevant auction based on a respective physical store location associated with the identified respective vendor;
determining distance information for each of the identified auctions in accordance with a distance parameter; and
returning a least a portion of the identified auctions to the search requester.

2. The method of claim 1, wherein the portion is ordered in accordance with the distance information.

3. The method of claim 1, further including validating at least one of the vendor physical store locations.

4. The method of claim 1, wherein the location condition is satisfied for an auction when the respective auction vendor is located equal to or within a distance parameter.

5. The method of claim 1, wherein the returning includes:
determining a map position for each of the auctions in the portion, the map position determined in accordance with the vendor physical store location of the respective vendor associated with the auction item; and
returning to the search requester a map including the determined map positions.

6. The method of claim 1, further including:
receiving a map request from the search requester for an identified auction;
determining map information in accordance with a respective vendor-physical store location of the respective vendor associated with the identified auction; and
returning the map information to the search requester.

7. The method of claim 1, further comprising:
receiving bid information from the search requester;
receiving notification information from the search requester; and
sending a bid notification message to the search requester when a notification condition is met, the bid notification including executable instructions for receiving a new bid and for receiving a new maximum bid.

8. The method of claim 7, further comprising:
receiving a response to the bid notification message; and
modifying the bid information of the search requester in accordance with the response.

9. A method of responding to a bid notification message from an auction host in a client device having a response application, comprising:
receiving the bid notification message in a client device via a wireless connection;
providing through a user interface for the client device a first option to increase a maximum bid amount and a second option to make a new bid via the response application;
receiving via the response application a response from the user interface, the response including bid information; and
sending the response to the auction host from the client device via the wireless connection.

10. The method of claim 8, wherein the bid notification message includes executable instructions for providing through the user interface the first option and the second option.

11. A computer program product, for use with a computer system, the computer program product comprising:
instructions for maintaining a database of vendor physical store locations where items offered for auction may be examined, each vendor physical store location associated with a respective vendor;
instructions for receiving an auction search request from a search requestor, the auction request including item description information and a location condition;
instructions for identifying auctions relevant to the item description information;
instructions for identifying a respective vendor associated with each auction of the identified relevant auctions;
instructions for satisfying the location condition for a respective identified relevant auction based on a respective physical store location associated with the identified respective vendor;
instructions for determining distance information for each of the identified auctions in accordance with a distance parameter; and
instructions for returning a least a portion of the identified auctions to the search requestor.

12. The computer program product of claim 11, further including instructions for ordering the portion in accordance with the distance information.

13. The computer program product of claim 11, further including instructions for validating at least one vendor physical store location

14. The computer program product of claim 11, further including instructions for satisfying the location condition for an auction when the respective auction vendor is located equal to or within a distance parameter.

15. The computer program product of claim 11, wherein the instructions for returning include:
instructions for determining a map position for each of the auctions in the portion, the map position determined in accordance with the vendor physical store location of the respective vendor associated with the auction item; and
instructions for returning to the search requester a map including the determined map positions.

16. The computer program product of claim 11, further comprising instructions for:
receiving a map request from the search requester for an identified auction;
determining map information in accordance with a respective vendor physical store location of the respective vendor associated with the identified auction; and
returning the map information to the search requester.

17. The computer program product of claim 11, further comprising instructions for:
receiving bid information from the search requester;
receiving notification information from the search requester; and
sending a bid notification message to the search requester when a notification condition is met, the bid notification including executable instructions for receiving a new bid and for receiving a new maximum bid.

18. The computer program product of claim 17, further comprising instructions for:
receiving a response to the bid notification message; and
modifying the bid information of the search requester in accordance with the response.

19. A computer program product, for use with a client device, the computer program product comprising:
instructions for receiving a bid notification message in the client device from an auction host;
instructions for providing through a user interface for the client device a first option to increase a maximum bid amount and a second option to make a new bid;
instructions for receiving a response from the user interface, the response including bid information; and
instructions for sending the response to the auction host from the client device.

20. A computer system for hosting on-line auctions, comprising:
a processor;
a memory in communication with said processor, said memory including
a database module including information pertaining to a plurality of vendors, including location information, and information pertaining to items to be marketed or auctioned by the plurality of vendors,
software instructions for hosting a on-line auction of the items, and
a customer relations management tool for management of the items to be marketed or auctioned; and
a communications interface in communication with said memory and said processor, said communications interface for communicating with a customer or one of the plurality of vendors over a network.

21. The system of claim 20, further comprising a mapping engine for generating a map based upon the location information, wherein the map is related to auction items located within a particular geographic region defined by the user.
